(19) United States
(12) Patent Application Publication
(10) Pub. No.: US 2011/0185308 A1
(43) Pub. Date: Jul. 28, 2011

(54) PORTABLE COMPUTER DEVICE

(75) Inventor: Satoshi MACHIDA, Tokyo (JP)

(73) Assignee: KABUSHIKI KAISHA TOSHIBA, Tokyo (JP)

(21) Appl. No.: 12/872,265

(22) Filed: Aug. 31, 2010

(30) Foreign Application Priority Data
Jan. 27, 2010 (JP) 2010-15924

(51) Int. Cl. G06F 3/048; G06F 3/041

(52) U.S. Cl. 715/784; 345/173

(57) ABSTRACT

In one embodiment, a portable computer device is equipped with a display for displaying information, a sensor for detecting a touch to the display, and a control unit. The control unit displays a first image data and a second imaged data which is an enlarged image data of the first image data, scrolls the enlarged image data when a tracing operation is detected by the sensor and a scroll mode is set, and selects at least one object contained in the enlarged image when the tracing operation is detected by the sensor and a selection mode is set.

### CROSS-REFERENCE TO RELATED APPLICATION(S)

This application is based upon and claims the benefit of priority from Japanese Patent Application No. 2010-15924, filed Jan. 27, 2010; the entire contents of which are incorporated herein by reference.

### FIELD

Embodiments described herein relate generally to a portable computer device.

### BACKGROUND

There has been an increase in mobile electronic apparatuses such as mobile phones or PDAs (Personal Digital Assistants) in which an input device is integrally formed with a display device by employing a touch panel.

Generally, in such an electronic apparatus, since the size of a screen is limited, characters displayed on a display device become increasingly smaller. In this regard, the number of electronic apparatuses having a function for enlarging and displaying an image displayed on the display device has been increased.

If the image is enlarged and displayed, characters and the like are also enlarged and displayed. However, since a part of displayed information is not displayed, it is necessary to perform a scroll operation.

### BRIEF DESCRIPTION OF THE DRAWINGS

FIG. 1 is a diagram illustrating the external appearance of a mobile phone in accordance with one embodiment;

FIG. 2 is a schematic diagram illustrating the internal configuration of a mobile phone in accordance with one embodiment;

FIG. 3 is a diagram illustrating one example of the aspect in which a part of an image displayed on a display section is enlarged and displayed on the whole of a display screen;

FIG. 4 is a diagram illustrating one example of the aspect in which an enlarged display frame is displayed on a display section, and a part of an image surrounded by the enlarged display frame in a display image is enlarged and displayed in the enlarged display frame;

FIG. 5 is a block diagram illustrating one example of each function performed by a CPU of a main control unit;

FIG. 6 is a diagram illustrating one example of the aspect in which a tracing operation is performed with respect to an enlargement image when an operation mode is a scroll mode;

FIG. 7 is a diagram illustrating one example of the aspect in which a tracing operation is performed with respect to an enlargement image when an operation mode is a selection mode;

FIG. 8 is a diagram illustrating one example of the soft key for determining an operation mode;

FIG. 9 is a diagram illustrating the aspect in which an operation mode is changed from one to the other by pressing down a soft key in order to determine an operation mode;

FIG. 10 is a diagram illustrating the aspect in which an operation mode is changed from one to the other according to an input operation;

FIG. 11 is a diagram illustrating the aspect in which a touch operation is performed with respect to an object to be selected of an enlargement image in a scroll mode, and an operation mode is automatically changed to a selection mode;

FIG. 12 is a diagram illustrating a aspect in which a tracing operation is performed with respect to an image except for an image to be selected of an enlargement image in a selection mode, and an operation mode is automatically changed to a scroll mode; and

FIG. 13 is a flowchart illustrating a process performed by a main control unit when an input operation is performed with respect to an enlargement image.

### DETAILED DESCRIPTION

In general, according to one embodiment, a portable computer device includes a display for displaying information, a sensor for detecting a touch to the display, a control unit for controlling to display a first image data and a second imaged data which is an enlarged image data of the first image data, scrolling the enlarged image data when a tracing operation is detected by the sensor and a scroll mode is set, and selecting at least one item contained in the enlarged image when the tracing operation is detected by the sensor and a selection mode is set.

Hereinafter, one embodiment will be described with reference to the accompanying drawings.

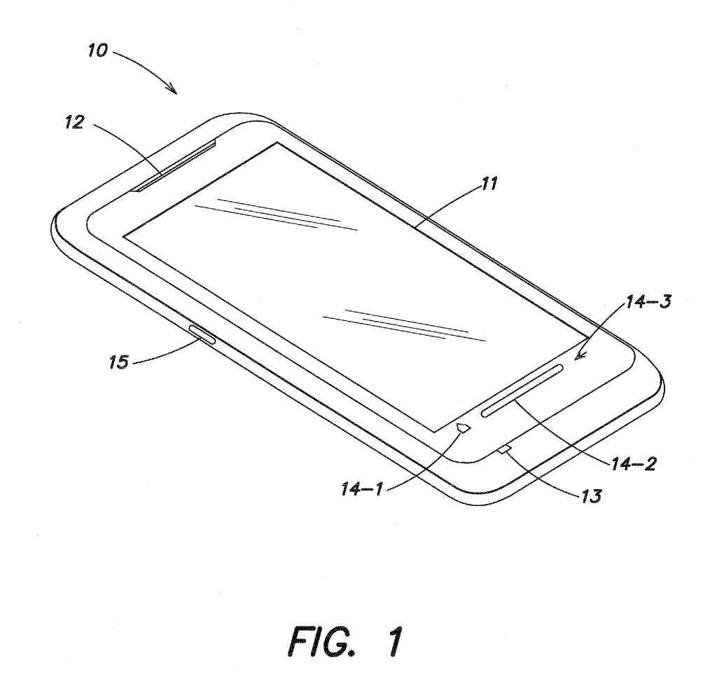

FIG. 1 is a diagram illustrating the external appearance of a mobile phone in accordance with one embodiment.

In addition, the mobile phone is one example, and the technology introduced in this embodiment can be applied to an electronic apparatus provided with a touch panel display device such as a PDA (Personal Digital Assistant) and a personal computer.

As shown in FIG. 1, the mobile phone 10 is provided at the surface side thereof with a touch panel display device 11, a speaker 12, a microphone 13, and touch keys 14-1 to 14-3. Furthermore, the mobile phone 10 is provided at the side thereof with a physical key 15.

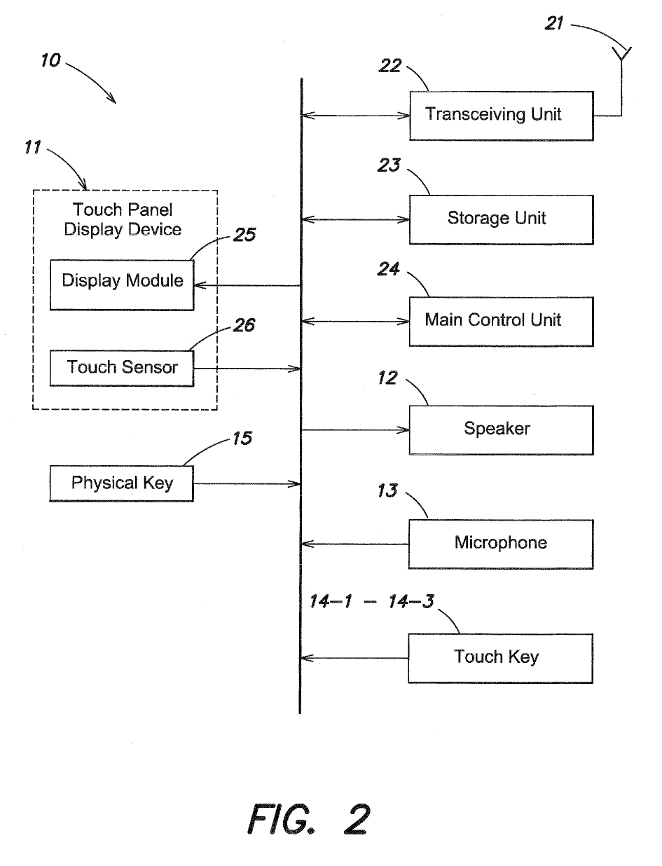

FIG. 2 is a schematic diagram illustrating the internal configuration of the mobile phone 10. As shown in FIG. 2, the mobile phone 10 includes at least an antenna 21, a transceiving unit 22, a storage unit 23 and a main control 4, unit 24, in addition to the elements described in FIG. 1.

The touch panel display device 11 includes a display module 25 such as a liquid crystal display or an organic EL (electroluminescence) display, and a touch sensor 26 provided over or underneath the display section 25 to detect contact with the display device.

The display module 25 is controlled by the main control unit 24 to display various images according to the execution of an application program such as a file management program or a web browser, an icon and a menu image for starting the application program and the like, a plurality of key images for inputting characters and numerals.

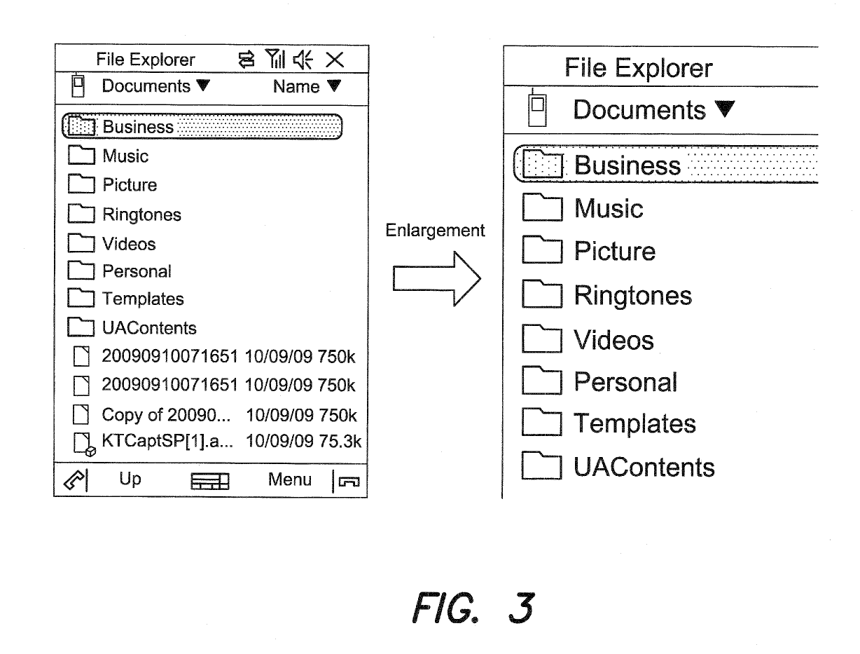

FIG. 3 illustrates an example in which an original image is displayed on the display module 25, and an example in which this image is enlarged and is displayed on the display module 25. In addition, in the following description, an image generated by the file management program is described as the image displayed on the display module 25.

The image generated by the file management program is a list of images including folders and files set in the same class of a hierarchical structure tree. Each folder and each file are selected based on input through the touch sensor 26.

When an enlargement process is selected through a pop-up image including a menu image displayed on the display module 25, the main control unit 24 controls a list of images displayed at this time to be enlarged and displayed on the display module 25. Furthermore, when the bar-shaped touch key 14-3 is traced, the main control unit 24 may control the list of images to be displayed after being enlarged or reduced according to the degree of movement of the traced trajectory. In addition, the main control unit 24 may detect that the predetermined position of the display module 25 is double tapped through the touch sensor 26, and perform enlargement or reduction of the list of images.

Furthermore, in the example of FIG. 3, the enlarged list of images is displayed over the entire display area of the display module 25.

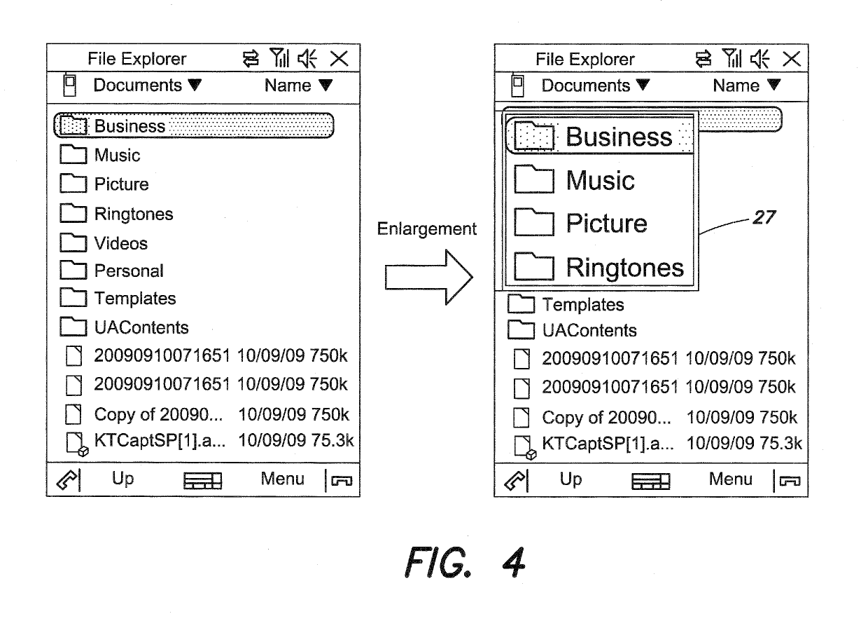

Meanwhile, FIG. 4 illustrates another example in which a display window 27 is popped up and displayed on the display module 25 and the enlarged list of images is displayed in the display window 27 in the case of enlarging and displaying the list of images. Furthermore, in this example, a part of a section of the list of images, which is covered by the display window 27, for example, is enlarged and displayed in the display window 27 by centering the left upper coordinate of the display window 27. In addition, the enlarged list of images displayed in the display window 27 can be scrolled, and the displayed folders and files can also be selected.

When contact by the fingers of a user is detected, the touch sensor 26 outputs the coordinate information of the contact position to the main control unit 24. For example, when a user performs an operation (hereinafter, referred to as “a plural selection operation”) for selecting a plurality of files from the list of images displayed on the display module 25, the user traces over a plurality of files to be selected. The touch sensor 26 detects coordinate information traced by the user and outputs the coordinate information to the main control unit 24. For example, when the touch sensor 26 is a capacitive sensor, the touch sensor 26 outputs coordinate information on the position, at which capacitive coupling has occurred between the fingertip and a conductive film, to the main control unit 24.

The speaker 12 outputs voice and audio such as a received voice during communication, and music played by a music player. Meanwhile, the microphone 13 receives a voice uttered from a user during communication.

The touch keys 14-1 to 14-3, for example, are configured by a capacitive touch sensor and have predetermined allocated functions. Furthermore, in this example, the touch key 14-1 is a home key. By touching the touch key 14-1, it is possible to return to a home screen displayed when the mobile phone 10 is powered on. In addition, the touch key 14-2 is a back key. When the touch key 14-2 is touched, it can be possible to close an image being displayed on the display module 25. Also, when the bar-shaped touch key 14-3 is traced, a web image and the like displayed on the display section 25 can be enlarged and reduced.

The keys 15 are physical keys and include a power key and a volume key.

The antenna 21 transmits/receives a radio signal to/from a base station of a mobile cell network (not shown). The transceiving unit 22 demodulates the radio signal received through the antenna 21 to generate an intermediate frequency signal, and modulates communication data output from the main control unit 24. The modulated communication data is transmitted to the base station through the antenna 21.

The storage unit 23 is a non-volatile memory in which data is rewritable, and for example, stores various types of data such as e-mail data and music data.

The main control unit 24 includes a CPU, a RAM, a ROM and the like, and controls an operation of the mobile phone 10 according to programs stored in the ROM. The CPU loads an operation mode control program stored in the ROM and data, which is necessary for executing an operation mode control program, to the RAM, and enlarges, reduces and scrolls the image displayed on the display module 25 by executing the operation mode control program.

The RAM provides a work area for temporarily storing programs and data to be executed by the CPU.

The ROM stores programs such as a start program of the mobile phone 10 and the operation mode control program, and various types of data necessary for executing these programs.

In addition, the ROM includes a magnetic or optical recording medium, a recording medium such as a semiconductor memory which is readable by a CPU. The programs and data in the ROM may also be downloaded in whole or in part through a network.

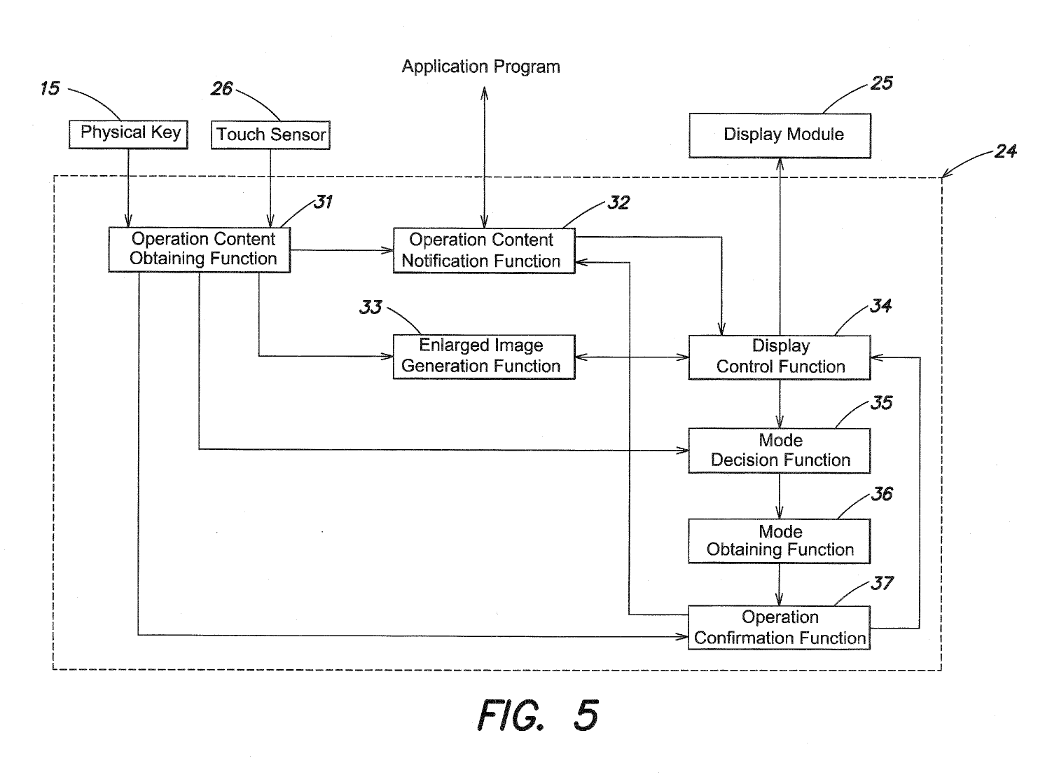

FIG. 5 is block diagram explaining functions in accordance with this embodiment, which are performed by the CPU of the main control unit 24. In addition, each function does not always need to be realized by programs, and may also be realized through hardware.

The CPU performs at least an operation content obtaining function 31, an operation content notification function 32, an enlarged image generation function 33, a display control function 34, a mode decision function 35, a mode obtaining function 36, and an operation confirmation function 37 by using the operation mode control program.

If the coordinate information detected by the touch sensor 26 is received, the operation content obtaining function 31 obtains time information regarding the time, at which the coordinate information is received, from a clock section in the main control unit 24. Thus, the operation content obtaining function 31 determines a touch and a release to the display module 25, and determines whether an input operation through the touch sensor 26 corresponds to a tracing, a touch and hold, a single tap or a double tap from the coordinate information and the time information.

Hereinafter, each input operation by a user through the display module 25 will be described. The touch represents a state change from a non-contact state to a contact state, and the release represents a state change from a contact state to a non-contact state. Furthermore, the touch and hold represents a state in which after the touch is detected, the contact state is held for a predetermined time (e.g., one second) or more, a so-called long pressing operation. In addition, the tracing represents a state in which after the touch is detected, the contact state is held and a contact position changes. Moreover, a tap represents that an interval between the touch and the release is detected for a predetermined time (e.g., one second) or less. The case in which the detection is performed once will be referred to as the single tap, and the case in which the detection is performed twice will be referred to as the double tap.

The operation content notification function 32 notifies the application program and the display control function 34 of the type of the input operation obtained by the operation content obtaining function 31, the coordinate information and the like. When the input operation is performed with respect to the image enlarged and displayed on the display module 25, the operation content notification function 32 calculates coordinate information, which is multiplied by the reciprocal of an enlargement factor, from the coordinate information detected by the touch sensor 26. The coordinate information obtained by the calculation is coordinate information before the image is enlarged, and the operation content notification function 32 notifies the application program of the coordinate information obtained by the calculation.

The enlarged image generation function 33 performs an enlargement process with respect to the image displayed on the display module 25 based on a preset magnification or a magnification designated through the touch key 14-3. Then, the enlarged image generation function 33 selects a part of the obtained enlargement image, which can be displayed on the display area of the display module 25. In addition, the enlarged image generation function 33 may also be a part of the function performed by the application program.

The display control function 34 displays the list of images (hereinafter, referred to as an enlarged image), which is enlarged by the enlarged image generation function 33, on the display area of the display module 25. Furthermore, the display control function 34 performs a scroll operation with respect to the enlarged image displayed on the display module 25, or a selection operation with respect to the files or folders based on the instructions from the operation confirmation function 37, and controls the operation result to be displayed on the display module 25.

Hereinafter, the operation of the mobile phone using a scroll mode and a selection mode in accordance with this embodiment will be described.

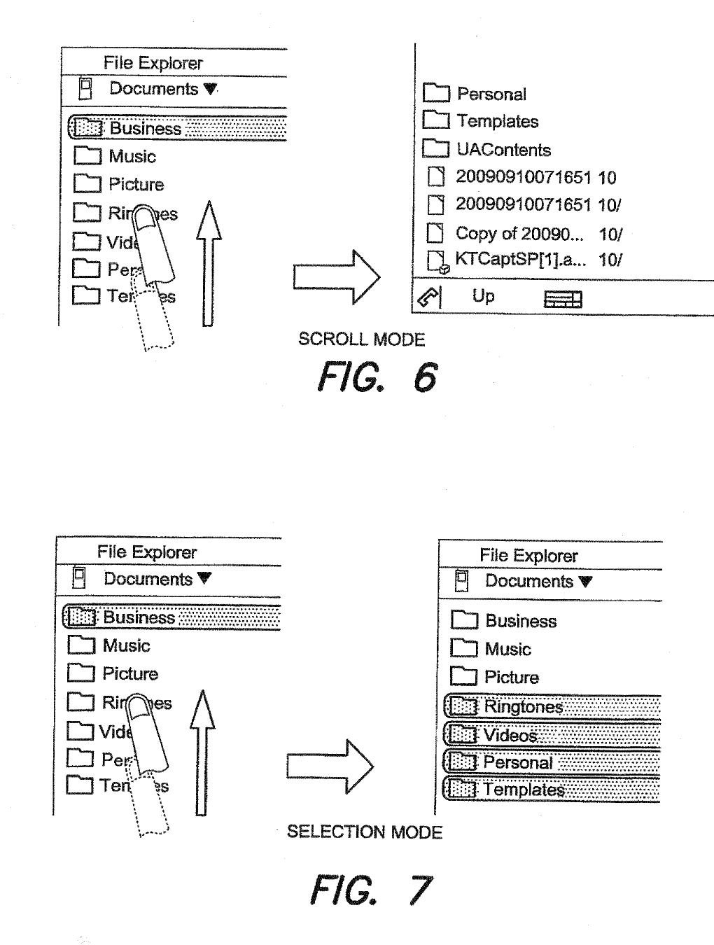

FIG. 6 illustrates one example in which a tracing operation is performed after the scroll mode is selected, and FIG. 7 illustrates one example in which the tracing operation is performed after the selection mode is selected.

When the scroll mode is selected, if the tracing operation is detected through the touch sensor 26, the main control unit 24 scrolls the enlarged image according to the movement degree by the tracing operation. At this time, as shown in FIG. 6, for example, even if an area where an object (a file, a folder and the like) to be selected is displayed is traced, a selection process for the object to be selected is not performed and the enlarged display image is scrolled.

Thus, a tracing operation is performed after the scroll mode is selected, so that the enlarged image can be scrolled without erroneously selecting the object to be selected.

In addition, FIG. 6 illustrates an example in which menu bars displayed at the upper and lower portions of the screen are also scrolled. However, the menu bars may not be scrolled or be enlarged.

Meanwhile, when the operation mode is selected, if the tracing operation is detected through the touch sensor 26, the main control unit 24 checks whether the trajectory of the tracing operation has passed through the display area of the object (e.g., the file, the folder and the like) to be selected based on the trajectory of the tracing operation, that is, the coordinate information detected by the touch sensor 26. Then, the main control unit 24 inverts and displays an object to be selected in the display area through which the trajectory of the tracing operation has passed. At this time, a scroll process is not performed with respect to the enlargement image according to the tracing operation.

The mode decision function 35 stores the scroll mode or the operation mode, which is selected based on the input through the touch sensor 26, in the RAM of the main control unit 24.

The mode obtaining function 36 reads the operation mode stored in the RAM, and outputs the obtained operation mode to the operation confirmation function 37.

If contents of an input operation using a hard key 16 and the touch sensor 26 are obtained through the operation content obtaining function 31, the operation confirmation function 37 confirms a process for an image, which is displayed on the display module 25, based on the operation mode notification from the mode obtaining function 36, and notifies the display control function 34 of the confirmation result.

For example, when the current operation mode is the selection mode and the contents of the input operation notification from the operation content obtaining function 31 are the single tap, the operation confirmation function 37 determines that the input operation is an operation for selecting one of the file and the folder included in the enlargement image.

In addition, when a normal display image not being enlarged is displayed on the display module 25, the operation confirmation function 37 does not determine a process for an input operation by taking the operation mode into consideration. This is because an erroneous operation of the scroll operation and the plural selection operation does not easily occur at the time of normal display as compared with the time of enlargement display.

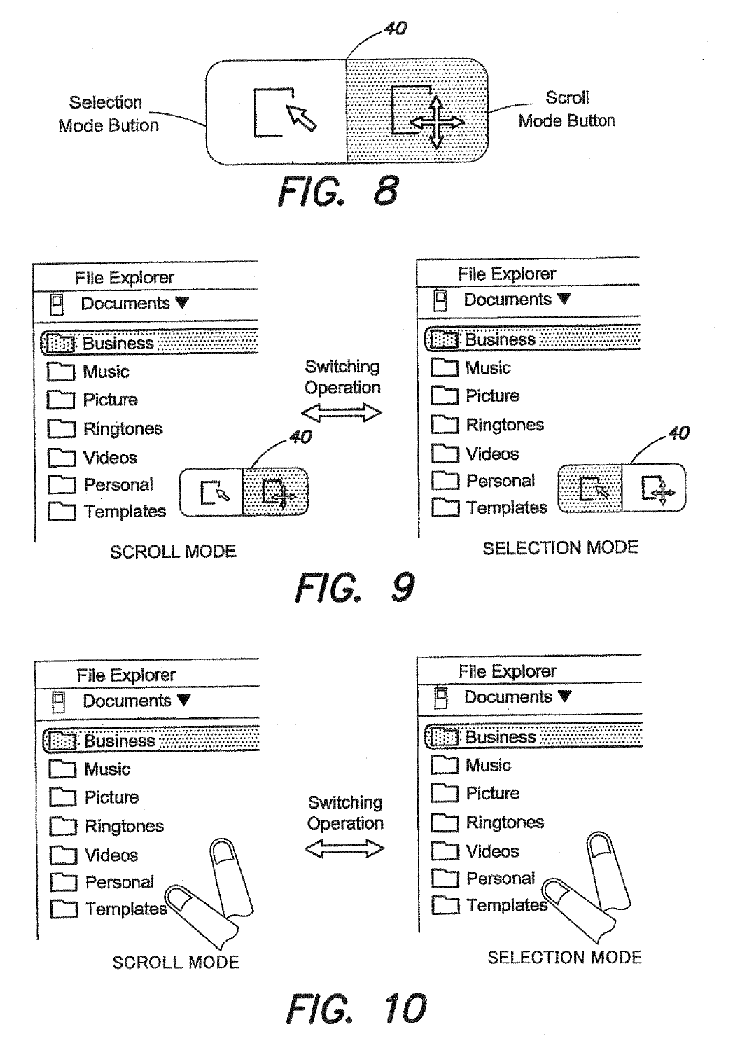

Moreover, the above description shows an example in which the operation mode is decided in advance through the touch sensor 26. Hereinafter, other examples in which the operation mode is decided will be described with reference to FIGS. 8 to 12.

In the first example, when an enlarged image is displayed on the display module 25, a switching button 40 is displayed on the display module 25 in order to change the operation mode from one to the other. The switching button 40 is a soft key. When areas corresponding to each operation mode are touched, the selection mode or the scroll mode is set.

FIG. 8 illustrates an example of the switching button 40 and FIG. 9 illustrates an example in which the switching button 40 is displayed on the display module 25 and the operation mode is switched by touching the switching button 40.

As shown in FIG. 9, the mode decision function 35 accepts a request for changing the operation mode from one to the other according to the touch operation or the tracing operation with respect to the switching button 40, and stores the accepted operation mode in the RAM of the main control unit 24 as the current operation mode. For example, if a selection mode button is pressed during the scroll mode, the scroll mode is switched to the selection mode.

In addition, the switching button 40 may also always be displayed when an enlarged image is displayed, or may also be displayed according to a predetermined operation by a user.

In the second example, if a predetermined input operation is performed, the operation mode is switched from one to the other.

FIG. 10 illustrates the aspect in which the operation mode is switched from one to the other according to the predetermined input operation. In addition, the predetermined input operation may use an input operation which is not used in both the scroll mode and the selection mode. FIG. 10 illustrates an example in which two points on an enlarged image are simultaneously touched as the predetermined input operation.

If two points on the display module 25 are simultaneously touched, notification information representing that the two points have been simultaneously touched is sent from the operation content obtaining function 31 to the mode decision function 35. If the notification is received, the mode decision function 35 changes the operation mode stored in the RAM of the main control unit 24 in order to change the operation mode from the current mode to the other mode. As a result, as shown in FIG. 10, the operation mode is switched between the scroll mode and the selection mode.

In the third example, when it is estimated that an operation by a user is not obviously performed in the current operation mode but the other operation mode, a change to the other operation mode is automatically performed.

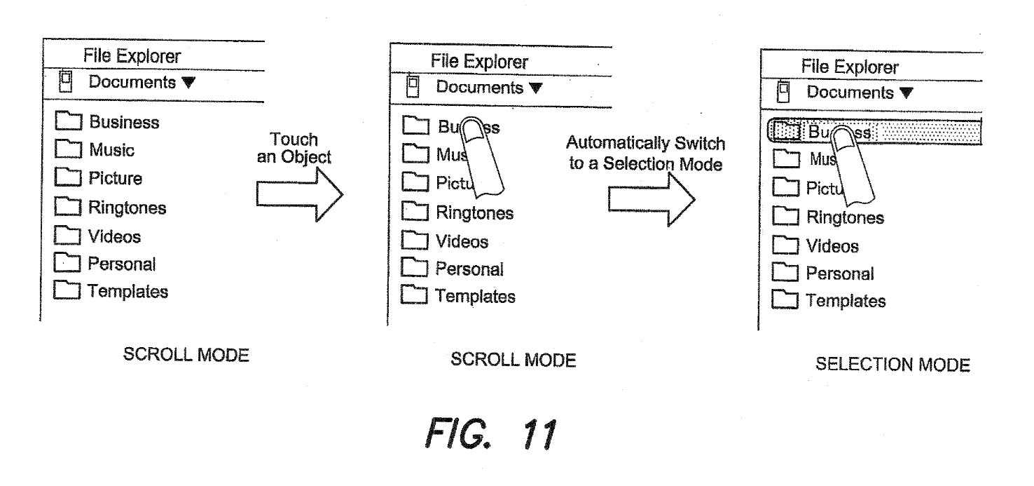

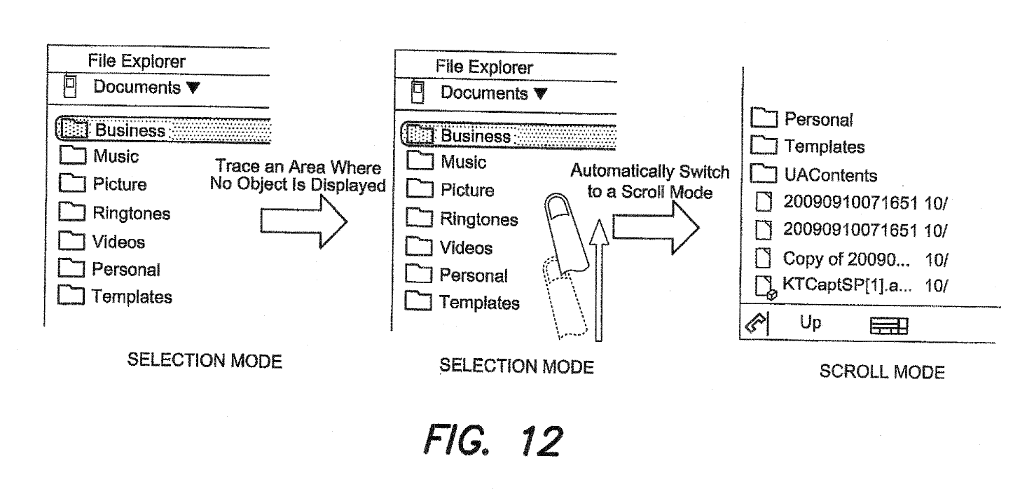

FIG. 11 illustrates that an object to be selected of an enlarged image displayed on the display module 25 is touched when the scroll mode is set, so that the operation mode is automatically changed to the selection mode. Meanwhile, FIG. 12 illustrates that a tracing operation is performed with respect to an image except for an image to be selected of an enlarged image displayed on the display module 25 when the selection mode is set, and the operation mode is automatically changed to the scroll mode. The object means an area in which an image such as a folder or a file and characters are displayed.

For example, as shown in FIG. 11, when the object to be selected is touched, it is probable that a user may forget that the scroll mode has been set and will perform a selection operation. If the object to be selected is touched, the mode decision function 35 performs an automatic change to the selection mode. Furthermore, the operation content obtaining function 31 notifies the operation content notification function 32 of the coordinate information detected through the touch sensor 26.

In addition, when considering the case in which the selection operation in the scroll mode or the scroll operation in the selection mode is an erroneous operation, the selection operation or the scroll operation by a user may be accepted under stricter criteria as compared to a normal selection operation or scroll operation. For example, in the case in which the selection operation is performed in the scroll mode, when it is detected that an object to be selected is not only touched but also held for a predetermined time or more, it may be determined that the selection operation is performed.

Furthermore, in this example, an automatic change to the other operation mode is performed, and the operation inputted through the touch sensor 26 is performed. However, only a change to the other operation mode may be performed, and an inputted operation may be allowed to be performed anew by a user.

Furthermore, in addition to the above examples, a function for changing the operation mode may be allocated to the hard key 15.

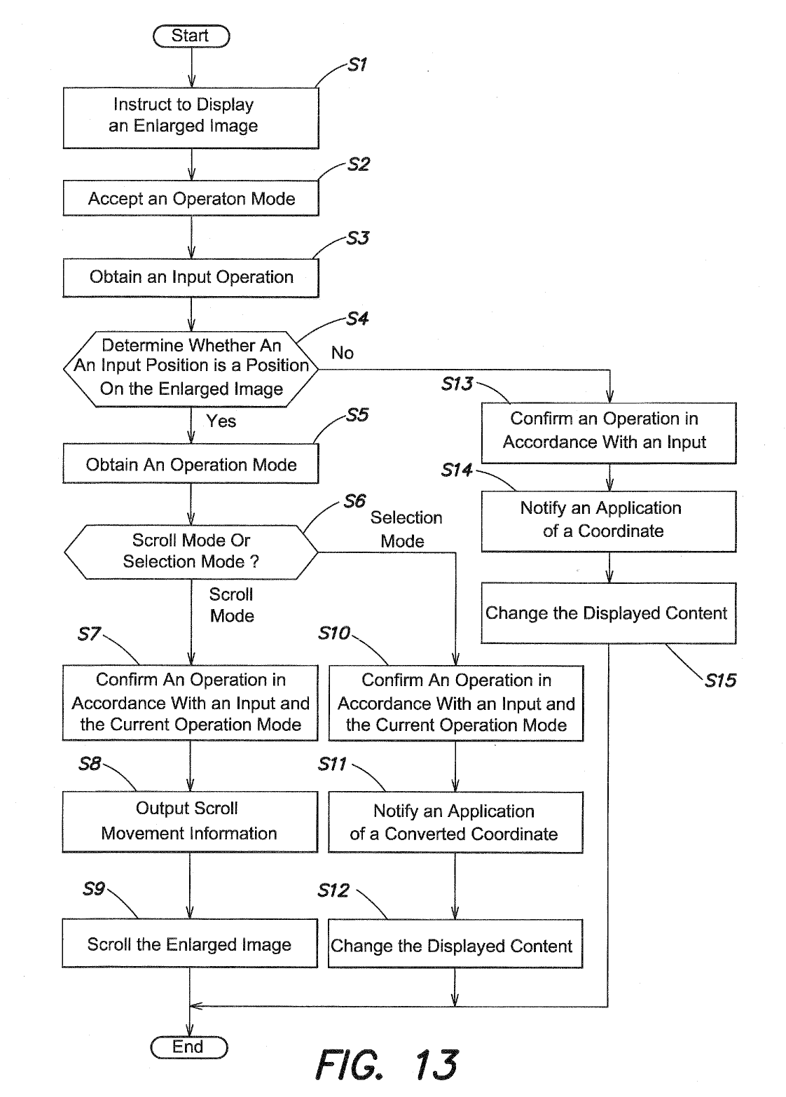

Next, one example of the operation of the mobile phone 10 in accordance with this embodiment will be described. FIG. 13 is a flowchart illustrating the process when an input operation is performed with respect to an enlarged image by the main control unit 24 of the mobile phone 10 shown in FIG. 1.

This process is started by instructing to enlarge an image displayed on display module 25 through the touch panel display device 11. In addition, as shown in FIG. 3, the list of the folders and files generated by the file management program is displayed on the display module 25. Furthermore, the following description shows one example in which if the enlargement display function is performed, the selection image of the operation mode is displayed and the operation mode is selected by a user.

First, in step S1, the display control function 34 instructs the enlarged image generation function 33 to display the enlarged image on the display module 25.

Next, in step S2, the mode decision function 35 accepts selection of the operation mode by the user through the operation content obtaining function 31, and stores the selected operation mode in the RAM of the main control unit 24 as the current operation mode.

Then, in step S3, the operation content obtaining function 31 obtains the contents of an input operation through the touch sensor 26, and notifies the operation confirmation function 37 of the obtained contents.

Then, in step S4, the operation content obtaining function 31 determines an input position of the input operation through the touch sensor 26 is a position on the enlarged image displayed on the display module 25, or a position on a normal display image. When the input position is the position on the enlarged image, step S5 is performed. Meanwhile, when the input position is the position on the normal display image, step S13 is performed. For example, in the case where the enlarged image is displayed using the display window 27, when the outer side of the display window 27 is touched, since it is determined that the operation is an operation for the normal display image, step S13 is performed.

Then, in step S5, the mode obtaining function 36 reads the operation mode stored in the RAM of the main control unit 24.

Then, in step S6, the mode obtaining function 36 determines whether the current operation mode is the scroll mode or the selection mode, and notifies the operation confirmation function 37 of the determination result. When the current operation mode is the scroll mode, step S7 is performed. When the current operation mode is the selection mode, step S10 is performed.

Then, in step S7, the operation confirmation function 37 confirms an operation according to the contents of the input operation to the enlarged image, which is received from the operation content obtaining function 31, and the information (the scroll mode) of the current operation mode, which is received from the mode obtaining function 36. In the scroll mode, the tracing operation is allocated to the scroll operation of the enlarged image.

Then, in step S8, the operation confirmation function 37 outputs scroll movement information according to the direction and distance of the tracing operation to the display control function 34.

Then, in step S9, the display control function 34 scrolls the enlarged image based on the scroll movement information received from the operation confirmation function 37, so that a series of processes are ended.

Meanwhile, when it is determined that the current operation mode is the selection mode in step S6, the operation confirmation function 37 confirms an operation according to the contents of the input operation to the enlarged image, which is received from the operation content obtaining function 31, and the information (the selection mode) of the current operation mode, which is received from the mode obtaining function 36, in step S10. In the selection mode, the tracing operation is allocated to the plural selection operation of the object to be selected.

Then, in step S11, the operation content notification function 32 converts the contact position on the enlarged image from an enlargement coordinate to a normal coordinate, and notifies the application program of the contents of the input operation.

Then, in step S12, the display control function 34 receives data according to the contents of the input operation from the application program, and changes the display contents based on the data. For example, if the contents of the input operation represent selection of a folder contained in the enlarged image, folders and/or files contained in the selected folder is displayed on the display module 25 in an enlarged form.

Meanwhile, when it is determined that there is an input operation to the normal display image other than the enlarged image in step S4, the operation confirmation function 37 confirms an operation according to the contents of the input operation to the normal display image, which is received from the operation content obtaining function 31, without taking the information of the operation mode into consideration in step S13.

Then, in step S14, the operation content notification function 32 notifies the application program of the contents of the input operation including the information on the confirmed operation and information on a normal coordinate of the contact position.

Last, in step S15, the main control unit 24 receives data according to the contents of the input operation from the application program, and changes the contents of a display image on the display screen based on the data. For example, when the contents of the input operation represent the scroll operation of the normal display image, the normal display image is scrolled and displayed, and a part of the scrolled normal display image, which is surrounded by the display window 27, is partially enlarged and displayed.

By the above process sequence, the scroll operation and the selection operation to the enlarged image can be accurately performed.

The mobile phone 10 in accordance with this embodiment sets the scroll mode and the selection mode as the operation mode. In one mode, the other mode is prevented from being performed. Consequently, the scroll operation and the selection operation to the enlarged image can be accurately performed regardless of the operation skill level of a user. Thus, the mobile phone 10 can reduce correction work caused by an erroneous operation.

In addition, the invention is not limited to the above embodiments, and elements can be modified without departing from the scope of the invention.

What is claimed is:

1. A portable computer device comprising:
a display for displaying information;
a sensor for detecting a touch to the display;
a control unit for displaying a first image data and a second imaged data which is an enlarged image data of the first image data, scrolling the enlarged image data when a tracing operation is detected by the sensor and a scroll mode is set, and selecting at least one object contained in the enlarged image when the tracing operation is detected by the sensor and a selection mode is set.

2. The portable computer device according to claim 1, wherein the control unit scrolls the enlarged image data or selects the at least one object contained in the enlarged image data only when coordinate information detected by the sensor is in an area where the at least one object is displayed.

3. The portable computer device according to claim 1, the control unit controls to display a switch button on the display so as to switch between the scroll mode and the selection mode by touching the switch button.

4. The portable computer device according to claim 1, wherein the control unit controls to display a window, in which the enlarged image is displayed, on the display.

5. The portable computer device according to claim 1, wherein the at least one object contained in the enlarged image data is folder in a hierarchical tree structure.

6. A portable computer device comprising:
means for displaying information;
means for detecting a touch to the display;
means for displaying a first image data and a second imaged data which is an enlarged image data of the first image data;
means for scrolling the enlarged image data when a tracing operation is detected by the sensor and a scroll mode is set; and
means for selecting at least one object contained in the enlarged image when the tracing operation is detected by the sensor and a selection mode is set.

7. The portable computer device according to claim 6, wherein the enlarged image data is scrolled only when sensed coordinate information is in an area where the at least one object is displayed.

8. The portable computer device according to claim 6, wherein the at least one object contained in the enlarged image data is selected only when sensed coordinate information is in an area where the at least one object is displayed.

9. The portable computer device according to claim 6, further comprising:
means for displaying a switch button on the display so as to switch between the scroll mode and the selection mode by touching the switch button.

10. The portable computer device according to claim 6, further comprising:
means for displaying a window, in which the enlarged image is displayed, on the display.

11. The portable computer device according to claim 6, wherein the at least one object contained in the enlarged image data is folder in a hierarchical tree structure.
